(19) United States
(12) Patent Application Publication
(10) Pub. No.: US 2011/0262776 A1
(43) Pub. Date: Oct. 27, 2011

(54) PERPENDICULAR MAGNETIC RECORDING MEDIUM WITH NON-AFC SOFT MAGNETIC UNDERLAYER STRUCTURE

(76) Inventors: Shih-Chin Chen, Taipei County (TW); Chang-Dar Tsai, Hsinchu County (TW); Yu-Wen Chen, Keelung City (TW); Shu-Hsien Liu, Taipei County (TW); Hsin-Yen Tsai, Taichung County (TW); Jie-Ming Chen, Taichung City (TW)

(21) Appl. No.: 12/765,889

(22) Filed: Apr. 23, 2010

(51) Int. Cl. G11B 5/706

(52) U.S. Cl. 428/846.6; 428/846

(57) ABSTRACT

A perpendicular magnetic recording medium is disclosed. The perpendicular magnetic recording medium includes a substrate; an intermediate layer disposed on the substrate; at least one soft underlayer (SUL) disposed between the substrate and the intermediate layer, wherein the soft underlayer contacts the intermediate layer and the substrate; and a magnetic recording layer disposed on the intermediate layer.

### BACKGROUND OF THE INVENTION

1. Field of the Invention

The invention relates to a perpendicular magnetic recording medium, and more particularly, to a perpendicular magnetic recording medium with Non-AFC soft magnetic underlayer structure.

2. Description of the Prior Art

With the advent of the Information Age, the amount of digital information that a person or organization deals with has significantly increased. For example, many people use computers that have high data processing speeds and large information storage capacities to access the Internet and obtain various pieces of information. Central processing unit (CPU) chips and computer peripheral units have been improved to enhance the speed of data processing in computers, and various types of high density information storage media like hard disks are being developed to enhance data storage capabilities of computers.

Recently, various types of recording media have been introduced. Most of the recording media use a magnetic layer as a data recording layer. Data recording types for magnetic recording media can be classified into longitudinal magnetic recording and perpendicular magnetic recording.

In longitudinal magnetic recording, data is recorded using the parallel alignment of the magnetization of the magnetic layer on a surface of the magnetic layer. In perpendicular magnetic recording, data is recorded using the perpendicular alignment of the magnetization of the magnetic layer on a surface of the magnetic layer. From the perspective of data recording density, the perpendicular magnetic recording is more advantageous than the longitudinal magnetic recording.

Improvement of recording densities of magnetic recording media requires improvement in the signal-to-noise ratio (SNR) and write-ability. Noise reduction of a magnetic recording medium has been conventionally accomplished by reducing the diameter of magnetic particles forming a recording layer and, further, magnetically isolating the magnetic particles in the magnetic recording medium, as well as the soft magnetic under layer (SUL) is used as part of the flux return path to enhance the write field from head during writing process.

Current SUL structure for perpendicular recording medium manufacturing typically involves an exchange coupling of two amorphous SUL to an antiferomagnetic layer, and is so-called AFC SUL structure. The material of SUL is preferably to be high magnetic flux density (Bs) and thick enough. This AFC SUL structure is to reduce the noise contributed by SUL during read-out of the recording data.

### SUMMARY OF THE INVENTION

It is an objective of the present invention to provide a perpendicular magnetic recording medium with improved signal-to noise ratio and write-ability.

According to a preferred embodiment of the present invention, a perpendicular magnetic recording medium is disclosed. The perpendicular magnetic recording medium includes a substrate; an intermediate layer disposed on the substrate; at least one soft underlayer (SUL) disposed between the substrate and the intermediate layer; and a magnetic recording layer disposed on the intermediate layer.

According to another aspect of the present invention, a perpendicular magnetic recording medium is disclosed. The perpendicular magnetic recording medium includes: a substrate; an intermediate layer disposed on the substrate; a plurality of soft underlayers disposed between the substrate and the intermediate layer; at least one spacer layer disposed between soft underlayers; and a magnetic recording layer disposed on the intermediate layer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a perspective view of a perpendicular magnetic recording medium according to a preferred embodiment of the present invention.

FIG. 2 illustrates a perspective view of a perpendicular magnetic recording medium according to an embodiment of the present invention.

FIG. 3 illustrates a perspective view of a perpendicular magnetic recording medium according to further embodiment of the present invention.

### DETAILED DESCRIPTION

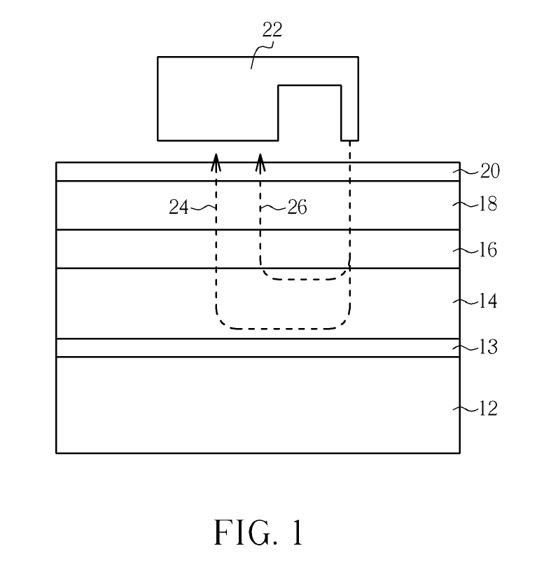

Referring to FIG. 1, FIG. 1 illustrates a perspective view of a perpendicular magnetic recording medium according to a preferred embodiment of the present invention. It should be noted that as area density becomes higher and higher, write width of the recording medium also becomes narrower and narrower. The magnetic field from head main pole to return pole of a magnetic head 22 also becomes narrower and narrower, such as from the field 24 to the field 26 as illustrated in FIG. 1. It is believed that thicker and high Bs SUL is no longer a constrain for future high density recording media. Hence, a Non-AFC SUL structure using low Bs (<=1 Tesla) and thinner amorphous SUL material proven to improve SNR & writability but does not contribute noise during read-out process is disclosed.

As shown in FIG. 1, the perpendicular magnetic recording medium includes a substrate 12, an adhesion layer 13, a soft underlayer 14, an intermediate layer 16, a magnetic recording layer 18, and a protective overcoat 20.

The substrate 12 that may be used in the embodiments of the invention includes glass, glass-ceramic, NiP/aluminum alloys. As the glass substrate, amorphous glass or crystallized glass is used. Examples of the amorphous glass include common soda lime glass and aluminosilicate glass. Examples of the crystallized glass include lithium-based crystallized glass.

The adhesion layer 13 that may be used in the embodiments of the invention could be any material that can provide good adhesive property to the substrate to prevent the thin film from peeling-off. The most typical material for this adhesion layer 13 is CrTi alloy. The thickness of adhesion layer is between 5-20 nm, but not limited thereto.

The soft underlayer 14 is preferably sandwiched between the adhesion layer 13 and the intermediate layer 16 without having any additional layers therebetween. In other words, the soft underlayer 14 is disposed to contact the top surface of the adhesion layer 13 and the bottom surface of the intermediate layer 16. Despite only one soft underlayer 14 is revealed in this embodiment, a structure having a plurality of soft underlayers 14 sandwiched between the adhesion layer 13 and the intermediate layer 16 without any additional layer therebetween could also be employed, which is also within the scope of the present invention.

In this embodiment, the soft underlayer 14 is preferably composed of Fe, Co, or FeCo based amorphous soft magnetic alloys, and one or more elements selected from a group consisting of Cr, Ta, Ti, B, Al, Zr, Ru, Nb, Ni, Si, V, W, Mo, Rh, Pd, Ag, Hf, Re, Ir, Pt, and Au is also added into this soft underlayer 14 for lowering the magnetic flux density (Bs) of the soft underlayer 14. Preferably, the atomic percent of total elements from the above group is equal or larger than 15% and the magnetic flux density (Bs) of the soft underlayer 14 is controlled less than 1 Tesla. The thickness of the soft underlayer 14 is preferably less than 100 nm, but not limited thereto.

The intermediate layer 16 formed between the soft underlayer 14 and the magnetic recording layer 18 is preferably composed of nonmagnetic material. The intermediate layer 16 has two functions including the function to cut the exchange coupling interaction between the soft underlayer 14 and the magnetic recording layer 18 and the function to control the crystallinity of the magnetic recording layer 18. In this embodiment, the thickness of the intermediate layer 16 is between 10-30 nm, and the material for the intermediate layer 16 could include Ru, Pd, Ta, Cr, NiW-based alloys.

The magnetic recording layer 18 is composed of one or more materials that have an easy axis of magnetization oriented substantially perpendicular to the substrate 12. In this embodiment, the thickness of the magnetic recording layer 18 is between 10-20 nm and the magnetic recording layer 18 is formed from a Co-alloy and may contain elements such as Cr and Pt as well as oxides such as SiO₂. One example of the magnetic recording layer 18 includes CoPtCr—SiOx. The magnetic recording layer 18 may contain one or more types of elements selected from B, Ta, Mo, Cu, Nd, W, Nb, Sm, Tb, Ru and Re besides Co, Cr, Pt and the oxides.

The protective overcoat 20 is provided for the purpose of preventing corrosion of the magnetic recording layer 18 and also preventing the surface of a medium from being damaged when a magnetic head is brought into contact with the medium. Preferably, the thickness of the protective overcoat 20 is between 1-5 nm and the material of the protective overcoat 20 is typically Diamond-like carbon (DLC).

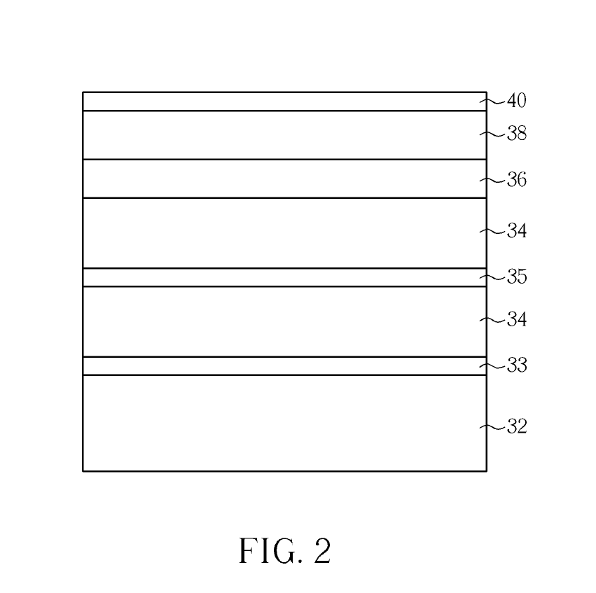

Referring to FIG. 2, FIG. 2 illustrates a perspective view of a perpendicular magnetic recording medium according to an embodiment of the present invention. As shown in FIG. 2, the perpendicular magnetic recording medium includes a substrate 32, an adhesion layer 33, a plurality of soft underlayers 34, a spacer layer 35 sandwiched between the soft underlayers 34, an intermediate layer 36, a magnetic recording layer 38, and a protective overcoat 40.

The substrate 32 that may be used in the embodiments of the invention includes glass, glass-ceramic, NiP/aluminum alloys. As the glass substrate, amorphous glass or crystallized glass is used. Examples of the amorphous glass include common soda lime glass and aluminosilicate glass. Examples of the crystallized glass include lithium-based crystallized glass.

The adhesion layer 13 that may be used in the embodiments of the invention could be any material that can provide good adhesive property to the substrate to prevent the thin film from peeling-off. The most typical material for this adhesion layer 13 is CrTi alloy. The thickness of adhesion layer is between 5-20 nm, but not limited thereto.

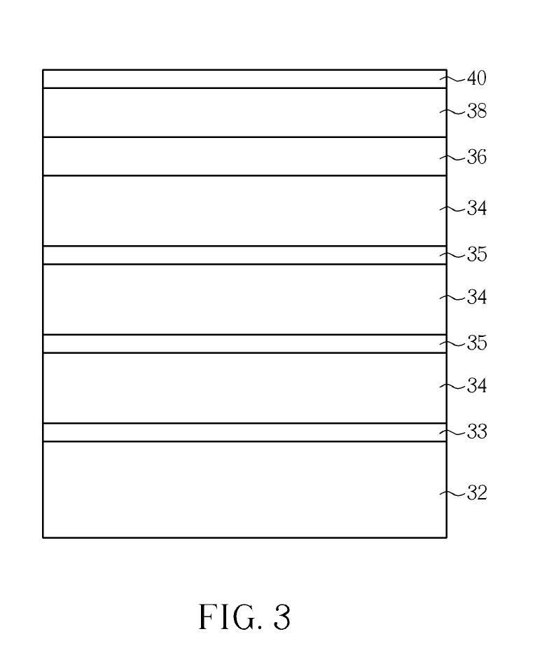

The two soft underlayers 34 are sandwiched between the adhesion layer 33 and the intermediate layer 36 with a spacer layer 35 therebetween. Despite only one spacer layer 35 and two soft underlayers 34 are revealed in this embodiment, the number of the spacer layer 35 and the soft underlayers 34 is not limited thereto and the vertically interlacing manner between the spacer layer 35 and the soft underlayers 34 could all be adjusted according to the demand of the product. For instance, two spacer layers 35 could be sandwiched between three soft underlayers 34, as shown in FIG. 3. Moreover, each of the soft underlayer 34 in FIG. 3 could also include a plurality of soft underlayers, which is also within the scope of the present invention. Similar to the aforementioned embodiment, the soft underlayers 34 are composed of Fe, Co, or FeCo based amorphous soft magnetic alloys, and one or more elements selected from a group consisting of Cr, Ta, Ti, B, Al, Zr, Ru, Nb, Ni, Si, V, W, Mo, Rh, Pd, Ag, Hf, Re, Ir, Pt, and Au is added into this soft underlayers 34 for lowering the magnetic flux density (Bs) of the soft underlayers 34. Preferably, the atomic percent of total elements from the above group is equal or larger than 15% and the magnetic flux density (Bs) of the soft underlayers 34 is controlled less than 1 Tesla. The total thickness of all soft underlayers 34 is preferably less than 100 nm and the thickness of the spacer layer 35 is between 0.3 nm to 5 nm, but not limited thereto. The material of the spacer layer 35 could be the same as or different from the material of the soft underlayers 34.

The intermediate layer 36 formed between the soft underlayers 34 and the magnetic recording layer 38 is preferably composed of nonmagnetic material. In this embodiment, the thickness of the intermediate layer 36 is between 10-30 nm, and the material for the intermediate layer 36 could include Ru, Pd, Ta, Cr, NiW-based alloys

The magnetic recording layer 38 is composed of one or more materials that have an easy axis of magnetization oriented substantially perpendicular to the substrate 32. In this embodiment, the thickness of the magnetic recording layer 38 is between 10-20 nm, and the magnetic recording layer 38 is formed from a Co-alloy and may contain elements such as Cr and Pt as well as oxides such as SiO₂. One example of the magnetic recording layer 38 includes CoPtCr—SiOx. The magnetic recording layer 38 may also contain one or more types of elements selected from B, Ta, Mo, Cu, Nd, W, Nb, Sm, Tb, Ru and Re besides Co, Cr, Pt and the oxides.

Preferably, the thickness of the protective overcoat 40 disposed on top of the magnetic recording layer 38 is between 1-5 nm and the material of the protective overcoat 40 is typically Diamond-like carbon (DLC).

Overall, the present invention disposes at least a soft underlayer between the adhesion layer and the intermediate layer of a perpendicular magnetic recoding medium, in which the soft underlayer could be a single layer contacting the adhesion layer and the intermediate layer or a plurality of soft underlayers interlaced with a plurality of spacer layers. The soft underlayer is preferably composed of Fe, Co, or FeCo based amorphous soft magnetic alloys, and one or more elements selected from a group consisting of Cr, Ta, Ti, B, Al, Zr, Ru, Nb, Ni, Si, V, W, Mo, Rh, Pd, Ag, Hf, Re, Ir, Pt, and Au is added into this soft underlayer. By adjusting the atomic percent of the element in the group, such as to a value equal or larger than 15%, the magnetic flux density (Bs) of the soft underlayer could be reduced to less than 1 Tesla. The SUL structure of the present invention is preferably a Non-AFC SUL structure, and even a spacer is disposed between two SUL, no antiferromagnetic coupling is observed between the two SUL, which is preferably the main difference between the present invention and the conventional SUL structure. As a result, the signal-to-noise ratio and write-ability of the perpendicular magnetic recording medium is improved substantially.

Those skilled in the art will readily observe that numerous modifications and alterations of the device and method may be made while retaining the teachings of the invention.

What is claimed is:

1. A perpendicular magnetic recording medium, comprising:
a substrate;
an intermediate layer disposed on the substrate;
at least one soft underlayer (SUL) disposed between the substrate and the intermediate layer, wherein the soft underlayer contacts the intermediate layer and the substrate; and
a magnetic recording layer disposed on the intermediate layer.

2. The perpendicular magnetic recording medium of claim 1, wherein the magnetic flux density (Bs) of the soft underlayer is less than 1 Tesla.

3. The perpendicular magnetic recording medium of claim 1, wherein the soft underlayer comprises Fe, Co, or FeCo based amorphous soft magnetic alloys.

4. The perpendicular magnetic recording medium of claim 1, wherein the soft underlayer further comprises one or more elements selected from a group consisting of Cr, Ta, Ti, B, Al, Zr, Ru, Nb, Ni, Si, V, W, Mo, Rh, Pd, Ag, Hf, Re, Ir, Pt, and Au.

5. The perpendicular magnetic recording medium of claim 4, wherein the atomic percent of total of Cr, Ta, Ti, B, Al, Zr, Ru, Nb, Ni, Si, V, W, Mo, Rh, Pd, Ag, Hf, Re, Ir, Pt, and Au in the soft underlayer is equal or larger than 15%.

6. The perpendicular magnetic recording medium of claim 1, wherein the thickness of the soft underlayer is less than 100 nm.

7. The perpendicular magnetic recording medium of claim 1, further comprising a carbon overcoat disposed on the magnetic recording layer.

8. The perpendicular magnetic recording medium of claim 1, wherein the at least one soft underlayer comprises a plurality of soft underlayers.

9. The perpendicular magnetic recording medium of claim 1, further comprising an adhesion layer disposed between the substrate and the soft underlayer.

10. A perpendicular magnetic recording medium, comprising:
a substrate;
an intermediate layer disposed on the substrate;
a plurality of soft underlayers disposed between the substrate and the intermediate layer;
at least one spacer layer disposed between the soft underlayers; and
a magnetic recording layer disposed on the intermediate layer.

11. The perpendicular magnetic recording medium of claim 10, wherein the magnetic flux density (Bs) of the soft underlayers is less than 1 Tesla.

12. The perpendicular magnetic recording medium of claim 10, wherein the soft underlayers comprise Fe, Co, or FeCo based amorphous soft magnetic alloys.

13. The perpendicular magnetic recording medium of claim 10, wherein the soft underlayers are selected from a group consisting of Cr, Ta, Ti, B, Al, Zr, Ru, Nb, Ni, Si, V, W, Mo, Rh, Pd, Ag, Hf, Re, Ir, Pt, and Au.

14. The perpendicular magnetic recording medium of claim 13, wherein the atomic percent of total of Cr, Ta, Ti, B, Al, Zr, Ru, Nb, Ni, Si, V, W, Mo, Rh, Pd, Ag, Hf, Re, Ir, Pt, and Au in the soft underlayers is equal or larger than 15%.

15. The perpendicular magnetic recording medium of claim 10, wherein the thickness of total of the soft underlayers is less than 100 nm.

16. The perpendicular magnetic recording medium of claim 10, further comprising a carbon overcoat disposed on the magnetic recording layer.

17. The perpendicular magnetic recording medium of claim 10, wherein the thickness of the spacer layer is between 0.3 nm to 5 nm.

18. The perpendicular magnetic recording medium of claim 10, wherein the at least one spacer layer comprises a plurality of spacer layers between the soft underlayers.
